(19) United States
(12) Patent Application Publication
(10) Pub. No.: US 2017/0077593 A1
(43) Pub. Date: Mar. 16, 2017

(54) Portable Device with Rear Charging Antenna

(71) Applicants: Yi-Chuan CHENG, Changhua County (TW); Kuo-Ching CHIANG, New Taipei City (TW)

(72) Inventors: Yi-Chuan CHENG, Changhua County (TW); Kuo-Ching CHIANG, New Taipei City (TW)

(21) Appl. No.: 15/342,088

(22) Filed: Nov. 2, 2016

Related U.S. Application Data
(63) Continuation-in-part of application No. 14/085,763, filed on Nov. 20, 2013.

(51) Int. Cl. H01Q 1/24; H01Q 1/22; H04B 5/00

(52) U.S. Cl. CPC H01Q 1/243; H04B 5/0037; H04B 5/0081; H01Q 1/2291

(57) ABSTRACT

A portable communicating device includes a control unit; a communication module is coupled to the control unit, a transparent rear shell is provided for minimizing EM shielding effect; a wireless charging antenna or coils is located corresponding to the transparent rear shell for improving charging performance, a wireless signal receiving/transmitting unit is coupled to the communication module, and is located corresponding to the transparent rear shell for improving signal receiving/transmitting performance; a front display is coupled to the control unit; a touch-sensing array is formed on the front display to sense at least one finger touch.

### CROSS REFERENCE TO RELATED APPLICATIONS

This application is a divisional application of Ser. No. 14/085,763, filed on Nov. 20, 2013, which is pending, and the content of the above-mentioned patent applications is hereby incorporated by reference herein in its entirety and made a part of this specification.

### TECHNICAL FIELD

The present invention relates generally to a portable device, and more particularly to an electronic device with rear charging antenna.

### BACKGROUND OF RELATED ARTS

It is common that a person owns more than one cellular phone. Some people even replace their cellular telephones as often as they replace their clothes or hairstyle. The cellular manufactures have to release new models with different appearances, function and styles more frequently so as to attract the attention of the buyer and occupy a favorable marketing share. Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone.

Furthermore, the conventional LCD display has a lot of drawbacks, for example, the LCD display cannot be bent and needs back light module which increases the thickness of the panel and it is not transparent. Liquid crystal material and color filter are also essential components to the display. Moreover, the device requires large arrays of thin film transistors, the manufacture is complicated and the resolution is not high enough. Further, the antenna of the conventional device is embedded within the device, and shield by a lot of IC or components. The signal reception is interrupted by a lot of device and EM shielding effect. The mouse is inconvenient to a user, especially, to a portable device. There is a desired to remove the mouse device. As recognized herein, for portability, it is desirable to configure the projector to be as slim as possible. But the goal of size reduction is frustrated by the present of the elements mentioned above. Pluralities of devices, such as mobile phone, PDA, GPS, smart phone, are developed recently. These devices allow the user communicates with other wirelessly, each of which utilizes some sort of user interface. The display of the devices having user interface typically maybe LCD or other type display. The display is typically configured to present visual information such as text and graphics. In most cases, the user interface is positioned on the front face of the electronic device for easy viewing and easy manipulation. However, the trend of the portable device is small, lightweight and multi-function.

### SUMMARY

A portable communicating device with an array of capacitors includes a control unit; a communication module is coupled to the control unit; a memory is coupled to the control unit; an antenna is coupled to the communication module; a display is coupled to the control unit and wherein the display includes a front side and a rear side, an image is displayed on the front side; an array of capacitors formed on the rear side to provide electricity. The capacitors include a first node and a second node. The first node and the second node include carbon nanotube, graphene, conductive polymer or the combination to achieve the purpose of flexible purpose, thereby providing the bending display with flexible power supply. The portable communicating device includes at least one finger detection sensor formed on the rear side to capture image of the user finger. The at least one finger detection sensor includes CMOS or CCD sensor to output control signal. The control signal includes cursor movement, character input, application instruction, webpage movement or image size change. A sensing array is formed on the rear side to sense at least one finger touch.

The display includes an OLED having a first electrode and a second electrode. The first electrode and the second electrode include carbon nanotube, grapheme, conductive polymer or the combination. The display includes a field emission device having a first electrode and a second electrode. The first electrode and the second electrode include carbon nanotube, graphene, conductive polymer or the combination.

A portable communicating device with an array of capacitors includes a control unit; a communication module is coupled to the control unit; a memory is coupled to the control unit; an antenna is coupled to the communication module; a display is coupled to the control unit and wherein the display includes a front side and a rear side, an image is displayed on the front side; an array of capacitors is formed on the rear side to provide electricity, wherein the capacitors includes a first node and a second node, wherein the first node and the second node include carbon nanotube, grapheme, conductive polymer or the combination to achieve the purpose of flexible purpose, thereby providing the bending display with flexible power supply. A sensing array is formed on the rear side to sense at least one finger touch. The sensing array includes a first node and a second node. The first node and the second node include carbon nanotube, grapheme, conductive polymer or the combination to achieve the purpose of flexible purpose. In another example, the portable communicating device comprises a control unit; a communication module is coupled to the control unit, a transparent rear shell is provided for minimizing EM shielding effect; a wireless charging antenna or coils is located corresponding to the transparent rear shell for improving charging performance, a wireless signal receiving/transmitting unit is coupled to the communication module, and is located corresponding to the transparent rear shell for improving signal receiving/transmitting performance; a front display is coupled to the control unit; a touch-sensing array is formed on the front display to sense at least one finger touch. The rear display is formed at said transparent rear shell. The rear display is an organic light-emitting display or electronic paper display. The electrode of the rear display is formed by carbon nanotube, graphene, conductive polymer or the combination.

### BRIEF DESCRIPTION OF THE DRAWINGS

FIG. 1 shows a diagram of a portable device according to the present invention.

FIG. 2-5 show a diagram of a displaying with an array of capacitors according to the present invention.

FIG. 6 shows a diagram of finger detection according to the present invention.

### DETAILED DESCRIPTION

The present invention relates generally to a computing or portable device. The device includes but not limited to cellular phone, tablet, PDA (personal digital assistant), smart phone, notebook, digital still camera, digital video camera, medium player (MP3, MP4), GPS and the equivalent thereof.

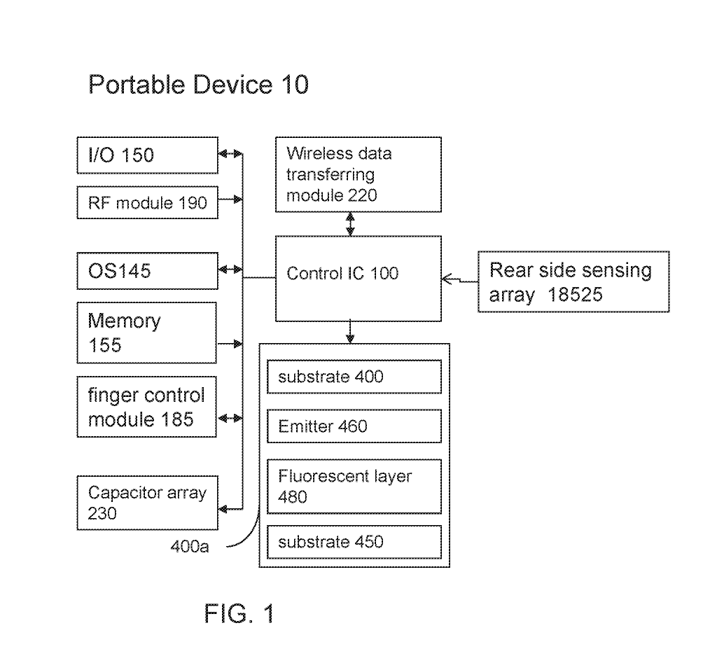

FIG. 1 is a diagram illustrating main components of a portable communication device having a panel with a capacitor array on a rear surface of a display substrate according to an embodiment of the present invention. The embodiment, as shown in FIG. 1, the device 10 includes a RF module 190. As known in the art, the RF module 190 includes antenna. This antenna is connected to a transceiver, which is used to receive and transmit signal. AS known, the RF module 190 further includes CODEC, DSP and A/D converter as well. Due to the RF module is not the feature of the present invention, therefore, the detailed description is omitted. The same reference numbers refers to similar component, however, the version, grade and performance maybe different. The present invention includes a central control IC 100, an input and output (I/O) unit 150, OS 145, the device 10 may include memory 155 such as ROM, RAM and FLASH memory. The RF module may perform the function of signal transmitting and receiving, frequency synthesizing, base-band processing and digital signal processing. If the portable device is cellular, SIM card hardware interface is provided for receiving a SIM card. Finally, the signal is send to the final actuators, i.e. a loudspeaker and a microphone or I/O 150.

The present invention further includes a wireless transmission/receiving module 220 coupled to the control IC 100. The transmission/receiving module is compatible with blue-tooth, home-RF, 802.11, WiFi standard or their higher version. The transmission domain (the air) by nature is not secured and therefore encryption maybe essential in the wireless transport networks. In one embodiment, pair-wise encryption/decryption between every neighboring wireless network device of a wireless transport network is well-known in the art. A data frame that leaves from one wireless device from one end of a wireless transport network to the other end of the same network might need several encryptions and decryptions before it reaches its final destination.

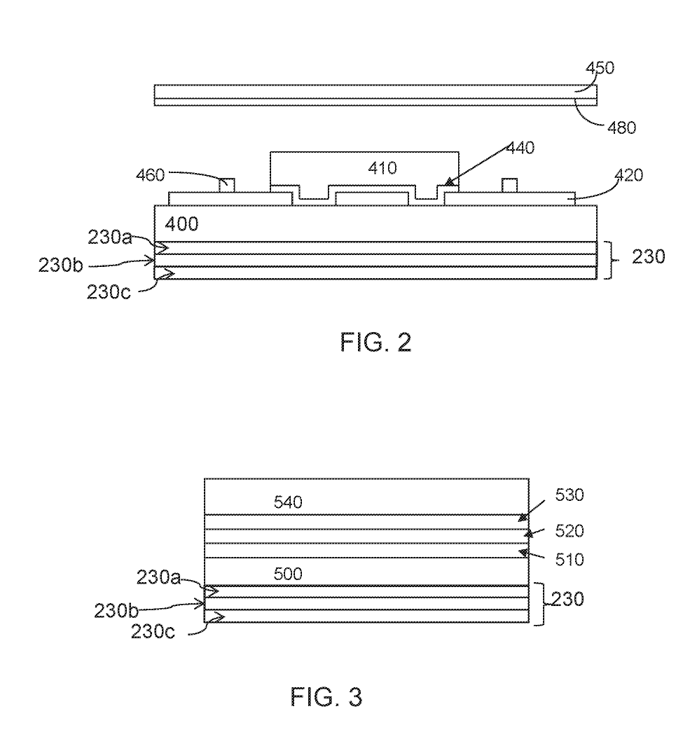

Almost all conventional devices include an antenna located within the portable device, the signal receiving performance is poor due to EM shielding effect generated by the shield, circuits, circuit board and other components. If the antenna to the signal is “transparency”, the performance will be improved. Therefore, in another aspect of the present invention is to provide an antenna located corresponding to a substantially transparent rear shell (rear cover) to minimize the EM shielding effect, thereby improving signal receiving/transmitting performance. The transparent rear shell (rear cover) is formed of glass, quartz, sapphire or the like. The antenna maybe provided for cellular transmission, NFC, blue-tooth transmission or wireless-charging. If it is provided for wireless-charging, the antenna maybe employed with coils or resonant type configuration. In one example, the transparent antenna is attached on the the transparent rear shell (rear cover) to minimize the EM shielding effect. In another example, at least one (transparent) antenna is attached on the substantially transparent rear display panel to minimize the EM shielding effect. The rear display could be formed by electronic paper type display. In one case, the rear display is provided for processing simple task such as making a call, reading, reviewing photo, recording memo. The non-transparency shell and antenna maybe provided as well. On the other hand, the consumer is unlikely to choose the product from various production if the product lacks of the product differentiation such that the product cannot be distinguish from the various similar product. Therefore, the present invention provides the device with transparent rear substrate (shell, cover) to allow the user or consumer may see through the rear display when the display is not displayed. The portable communicating device includes a transparent rear substrate (shell, cover) without opaque shell to allow the user may see-through the substrate or display. Therefore, the present invention provides see-through display visual effect. As seen in FIGS. 1 and 2, a substrate 400 is provided and transparent electrodes 420 are formed on the glass substrate 400. The substrate 400 could be flexible plastic or the like. The transparent panel or display is shown in FIG. 2, it is a cross-sectional view of the transparent panel or display without or with the opaque shell includes field emission devices according to the present invention. As seen in FIG. 2, the transparent panel or display without or with the opaque shell includes a transparent substrate 400 is provided and transparent electrodes 420 are formed on the flexible substrate 400. The transparent electrodes 420 may be made of indium tin oxide (ITO), carbon nanotube, graphene; and the material may be used as the emitter electrodes. The conductive polymer maybe added into the carbon nanotube or graphene. Stacked gate 410 that cover a portion of the transparent electrodes 420 are formed on the glass substrate 400. Emitters 460 that emit electrons are formed on a portion of the transparent electrode 420. Each stacked gate 410 includes a mask layer 440 that covers a portion of the transparent electrodes, and is formed by UV photolithograph mask. The mask layer 440 is preferably transparent to visible light, but opaque to ultra violet rays and can be made of an amorphous silicon layer. The silicon layer will be transparent when the thickness is thin enough. A stacked gate 410 structure includes first insulating layer/a gate electrode/a second insulating layer/focus gate electrode, sequentially formed over the substrate. The gate insulating layer is preferably a silicon oxide thin film and the gate electrode is made of chrome, carbon nanotube, graphene or the combination. The gate electrode is used for extracting an electron beam from the emitter. The focus gate electrode performs as a collector for collecting electrons emitted from emitter so that the electrons can reach a fluorescent film 480 disposed above the emitter 460. A front panel (substrate) 450 is disposed upward and above the stacked gate. A variety of visual images are displayed on the front panel 450. A fluorescent film 480 is attached to a bottom surface of the front panel 450 that faces the stacked gate and a direct current voltage is applied to the fluorescent film 480 to emit color for display. The fluorescent substance may emit color light by mixing the emitted light if the thin film with R, G, B fluorescent substances. Preferably, the fluorescent substances emit red, green, and blue visible light when excited by the electron beam is evenly distributed on the fluorescent film 480. Spacer separating the front panel 450 from the stacked gate is a black matrix layer and is not shown for convenience. Due to the thin film display is formed with thinner thick and the power consumption is lower than LCD, the present invention may provide smaller size, lighter weight device. The life time of battery may last longer. The field emission device does not require complicated, power-consuming back lights and filters which are necessary for LCD. Moreover, the device does not require large arrays of thin film transistors, and thus, a major source of high cost and yield problems for active matrix LCDs is eliminated. The resolution of the display can be improved by using a focus grid to collimate electrons. Preferably, the emitter includes a carbon nanotube emitter or graphene emitter to further reducing the device size and improve the resolution. Further, the transparent display may omit the liquid crystal material and opaque shell to reduce the thickness of the communication device and offer special visual effect. Further, the field emission display does not require the S/D regions which are required by TFT for LCD. An array of capacitors 230 is formed on the rear surface (side) of the display substrate. The display to emit image is refer to the front side and the opposite side refers to the rear side in the present invention. In FIG. 2, the capacitor array is formed under the substrate. The array of capacitors 230 includes at least three layers, a third electrode 230a and forth electrode 230c, a dielectric layer 230b is formed between the third electrode 230a and forth electrode 230b. The material for the third electrode 230a and forth electrode 230c may be nano siliver, carbon nanotube, conductive polymer or graphene. The composite of carbon nanotube-conductive polymer or graphene-conductive polymer may be used. These combinations may be used for the emitter. In one embodiment, the electrochemical storage of the electrical energy is achieved by redox reactions electrosorption or intercalation on the surface of the electrode by specifically adsorbed ions that results in a reversible faradaic charge-transfer on the electrode. The dielectric material is, for example, SiO.sub.2, SiO.sub.2/Si.sub.xN.sub.y, SiON, Al.sub.2O.sub.3, HfO.sub.2, HfSiO.sub.x, ZrO.sub.2, Ta.sub.2O.sub.5, TiO.sub.2, SrTiO.sub.3 (STO), SrBaTiO.sub.x (SBT), PbZrTiO.sub.x (PZT) or doped versions of the same such as Al:TiO.sub.2. These dielectric materials may be formed as a single layer or may be formed as a hybrid or nanolaminate structure. Optionally, the dielectric layer may receive a PDA treatment. A specific dielectric material of interest is the rutile-phase of TiO.sub.2.

In another embodiment, the transparent display is shown in FIG. 3. The display includes a transparent electrode 510 on a transparent substrate 500. A light-emitting film or powder 520 is attached to an upper surface of the lower transparent electrode 510. Preferably, the light-emitting film emits color light. The present invention includes three such components that separately display image in red components, green components, and blue component. Each irradiates single color light. Different light-emitting material will emit different color. An upper transparent electrode 530 is formed on the light-emitting film or powder 520. A transparent substrate 540 is formed on the transparent electrode 540. Both of the substrate are transparent and both two electrodes are transparent to allow the user may see-through the display. A bias is applied on the electrodes to inject hole and electron, thereby exciting the light-emitting substances by the combination of the electron and hole to emit red, green, or blue visible light depending on the compound of the light-emitting substances. The transparent electrodes 530 and 540 may be made of indium tin oxide (ITO), carbon nanotube, graphene. The conductive polymer maybe added into the carbon nanotube or grapheme. An array of capacitors 230 is formed on the rear surface (side) of the display substrate. The display to emit image is refer to the front side and the opposite side refers to the rear side in the present invention. In FIG. 2, the capacitor array is formed under the substrate. The array of capacitors 230 includes at least three layers, a third electrode 230a and forth electrode 230c, a dielectric layer 230b is formed between the third electrode 230a and forth electrode 230b. The composite of carbon nanotube-conductive polymer or grapheme-conductive polymer may be used. In one embodiment, the electrochemical storage of the electrical energy is achieved by redox reactions electrosorption or intercalation on the surface of the electrode by specifically adsorbed ions that results in a reversible faradaic charge-transfer on the electrode. The dielectric material is, for example, SiO.sub.2, SiO.sub.2/Si.sub.xN.sub.y, SiON, Al.sub.2O.sub.3, HfO.sub.2, HfSiO.sub.x, ZrO.sub.2, Ta.sub.2O.sub.5, TiO.sub.2, SrTiO.sub.3 (STO), SrBaTiO.sub.x (SBT), PbZrTiO.sub.x (PZT) or doped versions of the same such as Al:TiO.sub.2. These dielectric materials may be formed as a single layer or may be formed as a hybrid or nanolaminate structure. Optionally, the dielectric layer may receive a PDA treatment. A specific dielectric material of interest is the rutile-phase of TiO.sub.2.

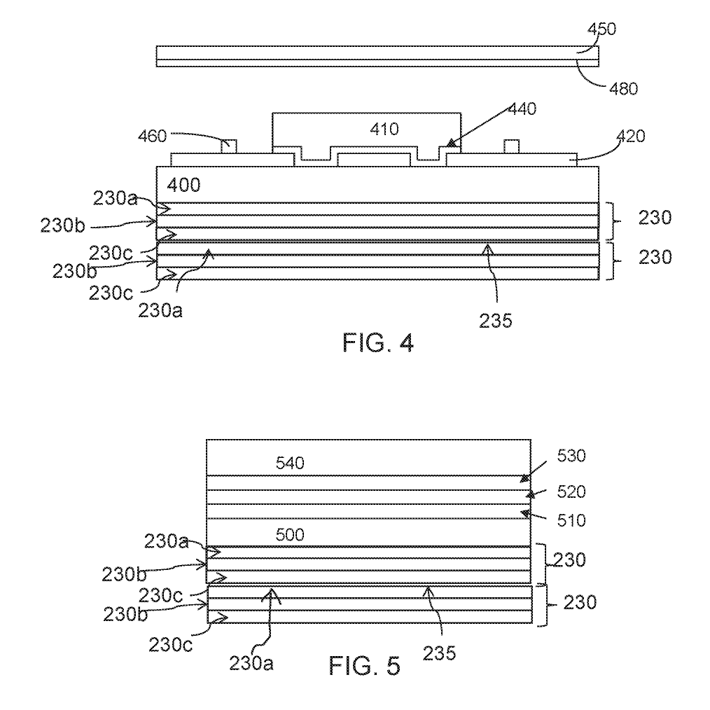

In another embodiment, further array of capacitor is stacked under the first array of the capacitor. The structure and the material is the same and the illustration is omitted. Please refer to FIG. 4 and FIG. 5. The first array and the second array are arranged in parallel connection or serious connection. An isolation layer 235 is formed between the arrays.

Furthermore, due to the substrate 400, 450 could be formed by flexible material, the electrodes employ the carbon nanotube, graphene. The conductive polymer maybe added into the carbon nanotube or graphene. Furthermore, a transparent antenna may be attached on the transparent panel to provide better signal transmission due to EM shield effect of the antenna will be minimized while the antenna is not set within the device. In this case, the antenna is composed by a material includes oxide containing metal or alloy, wherein the metal is preferable to select one or more metals from Au, Zn, Ag, Pd, Pt, Rh, Ru, Cu, Fe, Ni, Co, Sn, Ti, In, Al, Ta, Ga, Ge and Sb. Some of the transparent material includes oxide containing Zn with Al₂O₃ doped therein. The carbon nanotube, or graphene may be used as the antenna material. The conductive polymer maybe added into the carbon nanotube or graphene.

An array of capacitors is formed on the rear surface of the substrate of the display. The array of capacitors includes an array of third electrode which is formed under the rear surface of the substrate and a dielectric layer is laminated on the third electrode, an array of forth electrode is formed under the dielectric layer. The third electrode and the forth electrode is made of indium tin oxide (ITO), carbon nanotube, graphene. The conductive polymer maybe added into the carbon nanotube or grapheme.

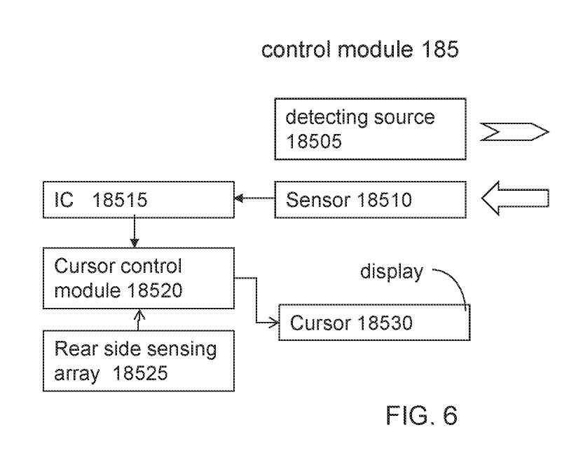

The present invention also provides a user control module 185 to control the cursor without mouse or touchpad as shown in FIG. 6. A computing device comprises a display and a detecting device on the display for detecting motion of a user. A movement information generating device is in responsive to the detection to generate an output signal, thereby generating movement information. A cursor control module is in responsive to the movement information to drive a cursor on the display corresponding to the movement information. Referring now to the drawings 6, there is shown in schematic form the basic components of the control module 185. The present invention includes a step of detecting the finger motion of a user by a CMOS sensor on the rear side of the portable device. The side with the display is defined as the front side and the opposite side is defined as rear side. Preferably, the portion for detection could be finger or the like. The finger detection will be introduced as one of the examples to illustrate the features of present invention. The subject's finger is positioned on the rear surface of the portable device. The control module 185 includes sensor and IC to detect finger motion and generate a control signal. A method is to detect the user finger motion or image by the sensor. The sensor 18510 could be optical sensor such as CMOS sensor or CCD. The outputs from the sensor 18510 are input to a processor or control integrated circuits 18515 to generate a control signal to a cursor control module 18520 for controlling a cursor on the display or panel. The image (finger) change of the user could be detected by the present invention. By means of image processing, the finger position information is evaluated. The control signal may drive the cursor 18530 to the position. The detecting source 18505 may be employed to provide the source.

The hand held electronic device also includes a display disposed within and viewable through an opening in the housing. The transparent display is typically placed on the front surface of the device 1310. The display provides visual information in the form of text, characters or graphics. By way of example, the rear, front display may correspond to a field emission display, organic light emitting diodes (OLED), or a display that is based on electronic inks, electronic paper.

In another example, in order to generate user inputs, the hand held electronic device may include a rear side sensing array 18525 that is not formed on the front surface of the display. On the contrary, the sensing array 18525 is formed on the rear side of the display. The sensing array generates input signals when an object such as a finger is moved across the surface of the sensing array, for example linearly, radially, rotary, etc., from an object holding a particular position on the array and/or by a finger tapping on the array. In most cases, the sensing array allows a user to initiate movements in a GUI by simply touching the display screen via a finger. The rear side sensing array allows the user to control the cursor by one hand. The display will keep clean due to the sensing array is not formed on the front side of the display. No finger print remains on the display. The hand held electronic device may be designed to recognize gestures applied to the rear side sensing array 18525 and to control aspects of the hand held electronic device based on the gestures. The gestures may be made through various particularly finger motions. The hand held electronic device may include a gesture operational program, which may be part of the operating system or a separate application. The gestural operation program generally includes a set of instructions that recognizes the occurrence of gestures and informs one or more software agents of the gestures and/or what action(s) to take in response to the gestures. The processor can be implemented on a single-chip, multiple chips or multiple electrical components. For example, various architectures can be used for the processor, including dedicated or embedded processor, single purpose processor, controller, ASIC, and so forth. In most cases, the processor together with an operating system operates to execute computer code and produce and use data. The operating system may correspond to well known operating systems such as OS/2, DOS, Unix, Linux, and Palm OS. Memory provides a place to store computer code, the memory may include Read-Only Memory (ROM), Random-Access Memory (RAM), hard disk drive, flash memory and/or the like. The display is generally configured to display a graphical user interface (GUI) that provides an easy to use interface between a user of the electronic device and the operating system or application running thereon. The electronic device also includes a touch screen that is operatively coupled to the processor. The touch screen is configured to transfer data from the outside into the device. The electronic device also includes a sensing device that is operatively coupled to the processor. The sensing device may also be used to issue web page moving commands. The sensing array display includes a first electrode and a second electrode. The first electrode and the second electrode include carbon nanotube, grapheme, conductive polymer or the combination.

Examples of hand held devices include PDAs, Cellular Phones (smart phone), Media player, Game players, Cameras, GPS receivers, notebook, tablet, digital camera, and the like. Therefore, the user may move the web page, image or document displayed on the page by directly moving the finger on the sensing array. The user may move the web-page, text, image, icon shown on the display directly by hand or user finger. Alternatively, the aforementioned embodiment may be used, independently or combination, to control or switch the TV channel, virtual object, volume and so on.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

We claim:

1. A portable communicating device comprising:
a control unit;
a communication module coupled to said control unit;
a transparent rear shell for minimizing EM shielding effect;
a wireless charging antenna or coils being located corresponding to said transparent rear shell for improving charging performance;
a wireless signal receiving/transmitting unit coupled to said communication module for signal receiving/transmitting;
a front display coupled to said control unit;
a touch-sensing array formed on said front display to sense at least one finger touch.

2. The portable communicating device of claim 1, further comprising at least one finger detection sensor formed on said transparent rear shell.

3. The portable communicating device of claim 1, further comprising a rear display formed at said transparent rear shell.

4. The portable communicating device of claim 3, wherein said rear display is an organic light-emitting display.

5. The portable communicating device of claim 1, wherein an electrode of said rear display is formed by carbon nanotube, graphene, conductive polymer or the combination.

6. The portable communicating device of claim 3, wherein said rear display is an electronic paper display.

7. The portable communicating device of claim 6, wherein an electrode of said rear display is formed by carbon nanotube, graphene, conductive polymer or the combination.

8. A portable communicating device comprising:
a control unit;
a communication module coupled to said control unit;
a transparent rear shell for minimizing EM shielding effect;
a wireless charging antenna or coils coupled to said communication module, and being located corresponding to said transparent rear shell for improving charging performance;
a front display coupled to said control unit;
a front touch-sensing array formed on said front display to sense at least one finger touch.

9. The portable communicating device of claim 8, further comprising at least one finger detection sensor formed on said transparent rear shell.

10. The portable communicating device of claim 8, further comprising a rear display formed at said transparent rear shell.

11. The portable communicating device of claim 10, wherein said rear display is an organic light-emitting display or electronic paper display.

12. The portable communicating device of claim 11, wherein an electrode of said rear display is formed by carbon nanotube, graphene, conductive polymer or the combination.

13. A portable communicating device comprising:
a control unit;
a communication module coupled to said control unit;
a transparent rear shell for minimizing EM shielding effect;
a wireless charging antenna or coils coupled to said communication module, and being located corresponding to said transparent rear shell for improving charging performance;
an organic light-emitting display front display coupled to said control unit;
a front touch-sensing array formed on said front display to sense at least one finger touch.

14. The portable communicating device of claim 13, further comprising at least one finger detection sensor formed on said transparent rear shell.

15. The portable communicating device of claim 14, further comprising a rear display formed at said transparent rear shell.

16. The portable communicating device of claim 15, wherein said rear display is an organic light-emitting display or electronic paper display.

17. The portable communicating device of claim 16, wherein an electrode of said rear display is formed by carbon nanotube, graphene, conductive polymer or the combination.
